(19) United States
(12) Patent Application Publication
(10) Pub. No.: US 2008/0226986 A1
(43) Pub. Date: Sep. 18, 2008

(54) Power Storage Device

(76) Inventors: Kentaro Nakahara, Tokyo (JP); Jiro Iriyama, Tokyo (JP); Shigeyuki Iwasa, Tokyo (JP); Masahiro Suguro, Tokyo (JP); Masaharu Satoh, Tokyo (JP)

Correspondence Address: HAYES SOLOWAY P.C., 3450 E. SUNRISE DRIVE, SUITE 140, TUCSON, AZ, 85718, US

(21) Appl. No.: 10/597,517

(22) PCT Filed: Dec. 17, 2004
(86) PCT No.: PCT/JP2004/018907

§ 371 Date: Jul. 27, 2006

(30) Foreign Application Priority Data
Feb. 16, 2004 (JP) 2004-038740

(51) Int. Cl. H01M 4/60

(52) U.S. Cl. 429/213

(57) ABSTRACT

An object of the present invention is to provide a power storage device with low internal resistance, employing a cathode containing a nitroxyl polymer. To attain the object in the present invention, in the power storage device employing a cathode comprising a nitroxyl polymer, a cathode collector having a conductive auxiliary layer comprising carbon as a main component formed and integrated on an aluminum electrode is used.

### TECHNICAL FIELD

The present invention relates to a power storage device with low internal resistance.

### BACKGROUND ART

A power storage device using a nitroxyl polymer as a cathode active material has been proposed. For example, in the conventional power storage device described in FIG. 1 of Patent Document 1, the power storage device is constructed by direct application or compression of a cathode having a nitroxyl polymer as an active material onto a cathode metal collector made of aluminum or stainless steel.

Patent Document 1: Japanese Patent Application Laid-Open No. 2002-304996.

### DISCLOSURE OF THE INVENTION

### Problem to be Solved by the Invention

The power storage device disclosed in Patent Document 1, however, has a problem of increasing the internal resistance of the device. The cause of the problem is that Schottky-type internal resistance is generated between a metal collector such as aluminum or stainless steel and a nitroxyl polymer being an organic semiconductor. As the result, energy loss due to the internal resistance increases. An object of the present invention is to provide a power storage device with low internal resistance, employing a nitroxyl polymer as a cathode active material.

### Means for Solving the Problem

<Feature of the Invention>

The present invention provides a power storage device comprising a nitroxyl polymer which has a nitroxyl cation partial structure represented by the following chemical formula (I) in oxidation state and has a nitroxyl radical partial structure represented by the following chemical formula (II) in reduction state, in a cathode; employing a reaction for transferring an electron between the two states represented by the following equation (B) as an electrode reaction of the cathode; and using a cathode collector having a conductive auxiliary layer comprising carbon as a main component formed and integrated on an aluminum electrode.

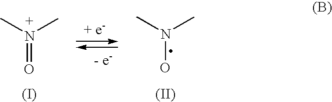

<Function>

The conductive auxiliary layer sandwiched between the cathode having a nitroxyl polymer as an active material and the aluminum electrode is effective in reducing the potential barrier between an organic polymer compound and a metal collector, to reduce the internal resistance of the power storage device.

### Effects of the Invention

According to the present invention, it is possible to provide a power storage device with low internal resistance by using a cathode collector having a conductive auxiliary layer comprising carbon as a main component formed and integrated on the aluminum electrode.

### BRIEF DESCRIPTION OF THE DRAWINGS

FIG. 1 is a schematic view showing the structure of a power storage device set forth in a first embodiment; and

FIG. 2 is an enlarged view of a cathode collector in the schematic view showing the structure of a power storage device set forth in the first embodiment.

### DESCRIPTION OF SYMBOLS

1. Anode metal collector
2. Insulating packing
3. Anode
4. Separator
5. Cathode
6. Cathode collector
7. Cathode metal collector
8. Conductive auxiliary layer
9. Aluminum

### BEST MODE FOR CARRYING OUT THE INVENTION

<Structure>

Next, the embodiments of the present invention will be more specifically explained with reference to the drawings.

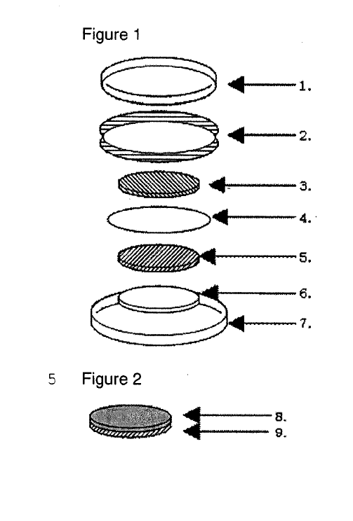

FIG. 1 shows a schematic view of a power storage device according to a first embodiment of the present invention.

FIG. 2 shows a schematic view of a cathode collector according to the first embodiment.

A power storage device according to the present invention, for example, has the structure shown in FIG. 1. The power storage device shown in FIG. 1 has a constitution in which an anode 3 and a cathode 5 are laminated through a separator 4 containing an electrolyte therebetween. As the cathode collector 6, a electrode having a conductive auxiliary layer 8 formed and integrated on an aluminum plate 9 as shown in FIG. 2 is used. The conductive auxiliary layer 8 according to the first embodiment is consisted of an acetylene black and a binder and formed and integrated on the aluminum plate by thin coating. The mixing ratio by weight of the acetylene black and the binder is that acetylene black/the binder is 88/12. An anode metal collector 1 and a cathode metal collector 7 according to the first embodiment are made of a stainless steel plate and laminated through a polypropylene insulating packing 2 therebetween to form a coin-type shape. In the first embodiment, lithium metal is used as the anode 3 and a nitroxyl polymer, poly(2,2,6,6-tetramethylpiperidine methacrylate) (PTMA) represented by chemical formula (1) is used as a cathode active material. PTMA used as the cathode active material is complexes with an electro-conductivity imparting agent containing acetylene black as a main component, and a binder containing polyvinylidene fluoride as a main component, to form the cathode 5. The weight ratio of these components is that PTMA/electro-conductivity imparting agent/binder is 5/3/2. As the separator 4 according to the first embodiment, a porous polypropylene separator is used. As the electrolyte according to the first embodiment, mixture solvent of ethylene carbonate (EC) and diethyl carbonate (DEC) (the volume ratio of EC/DEC is 3/7) containing 1 M LiPF₆ as a supporting salt is used.

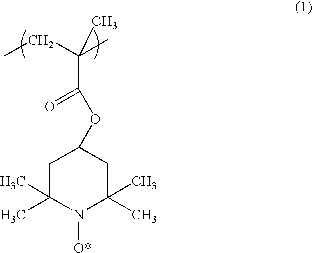

<Manufacturing Method>

Next, referring to FIG. 1, a method for manufacturing a power storage device according to the first embodiment will be explained.

In a 100 ml eggplant flask equipped with a reflux tube, 20 g (0.089 mol) of a 2,2,6,6-tetramethylpiperidine methacrylate monomer was placed and dissolved in 80 ml of dry tetrahydrofuran. To the solution, 0.29 g (0.00178 mol) of azobisisobutyronitrile (AIBN) (monomer/AIBN=50/1) was added and the resultant mixture was stirred under argon atmosphere at 75 to 80° C. After the reaction was performed for 6 hours, it was cooled to room temperature. The polymer was precipitated in hexane, separated by filtration, and dried under vacuum to obtain 18 g of poly(2,2,6,6-tetramethylpiperidine methacrylate) in a yield of 90%. Subsequently, 10 g of poly(2,2,6,6-tetramethylpiperidine methacrylate) thus obtained was dissolved in 100 ml of dry dichloromethane. To the solution, 100 ml of a dichloromethane solution of 15.2 g (0.088 mol) of m-chloroperbenzoic acid was dropped at room temperature while stirring for one hour. After further stirring for 6 hours, precipitated m-chlorobenzoic acid was filtered off and the filtrate was washed with an aqueous solution of sodium carbonate and water, and then dichloromethane was distilled away. The remaining solid was pulverized and the obtained powder was washed with diethyl carbonate (DEC), and then, dried under vacuum to obtain 7.2 g of poly(2,2,6,6-tetramethylpiperidine methacrylate) (PTMA) represented by chemical formula (2) in a yield of 68.2% as brown powder. The structure of the polymer thus obtained was confirmed by IR. As a result of GPC measurement, the weight average molecular weight (Mw) was 89,000 and dispersion Mw/Mn was 3.30. The spin density obtained from an ESR spectrum was 2.26×10²¹ spin/g. This value coincides with the spin density on the assumption that 90% of the N—H groups of poly(2,2,6,6-tetramethylpiperidine methacrylate) are converted into N—O radicals.

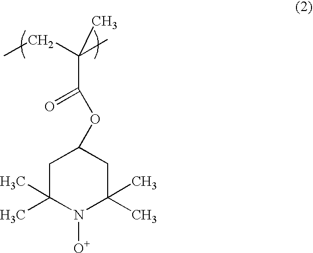

20 g of pure water was weighed and placed in a small homogenizer container. To the container, a binder (272 mg) consisted of Teflon (registered trade mark) particles and cellulose was added and completely dissolved by stirring for 3 minutes. To the mixture, 2.0 g of acetylene black was added and stirred for 15 minutes to obtain a slurry. The obtained slurry was thinly applied onto an aluminum plate with the thickness of 20 micron, and dried at 100° C. to form a conductive auxiliary layer. The thickness of the conductive auxiliary layer was 10 microns. In this way, a cathode collector was obtained having the conductive auxiliary layer containing carbon as a main component integrated with the aluminum plate.

Next, 20 g of N-methyl pyrrolidone was weighed and placed in a small homogenizer container. To the container, 400 mg of polyvinylidene fluoride was added and completely dissolved by stirring for 30 minutes. To the mixture, 1.0 g of synthetic polymethacrylate represented by chemical formula (2) was added and stirred for 5 minutes. When the whole mixture turned uniformly to orange, 600 mg of acetylene black was added and stirred for 15 minutes. The resultant sample was defoamed to obtain slurry. The obtained slurry was thinly applied onto the cathode collector having the conductive auxiliary layer containing carbon as a main component integrated on the aluminum plate and dried at 125° C. to form a cathode.

The electrode plate, in which the cathode was formed by applying slurry containing a nitroxyl polymer onto the cathode collector having the conductive auxiliary layer containing carbon as a main component integrated on the aluminum plate, was mounted on a cathode metal collector, dried at 80° C. under vacuum overnight and punched to form a disk shape with a diameter of 12 mm to form a electrode for a power storage device. Next, the electrode thus obtained was dipped into an electrolyte and space inside the electrode was impregnated with the electrolyte. As the electrolyte, an EC/DEC mixture solution containing 1 mol/L of an LiPF₆ electrolytic salt was used. Next, on the electrode impregnated with the electrolyte, a porous film separator impregnated with the electrolyte in the same manner was laminated. Further, a lithium metal plate as an anode was laminated and an anode collector coated with insulating packing was put on. The laminate formed in this manner was pressed by a caulker to obtain a coin-type power storage device.

<Other Embodiments of the Present Invention>

A power storage device, which is formed in a coin-type in the first embodiment, can be manufactured in a conventionally known shape. Examples of a power storage device shape include one where a laminate or a winding of electrode is encapsulated with a metal case, a resin case, a laminate film or the like. Examples of the outside shape include a cylinder type, a square type, a coin type and a sheet type.

A conductive auxiliary layer, which is formed by a coating method in the first embodiment, may be formed by a deposition method. When a conductive auxiliary layer containing a carbonaceous material as a main component is formed by a deposition method, the conductive auxiliary layer can be obtained as a thin coating film on the aluminum electrode. As a result, the resultant power storage device has a synergistic effect to improve energy density. The conductive auxiliary layer of the present invention serves as a layer for helping electrical-charge transfer between the cathode and aluminum, and contains a carbonaceous material as a main component. The main component used herein refers to a component whose content exceeds 50% by weight based on the total weight of the layer. Examples of the carbonaceous material include activated carbon, graphite, carbon black, furnace black, amorphous carbon and the like.

The thickness of the conductive auxiliary layer of the present invention is not particularly limited; however, it is preferably thinner in view of increasing the energy density of the power storage device. When the conductive auxiliary layer of the present invention is manufactured by a coating method, the thickness of the layer is generally within the range of about 3 to 1,000 microns. In view of increasing the energy density of the power storage device, the thickness of the layer is preferably 50 microns or less, and further preferably 20 microns or less. In the coating method, however, it is difficult to form an electrode having a uniform thickness of 1 micron or less while maintaining mechanical strength. In contrast, when the conductive auxiliary of the present invention is manufactured by a deposition method, a thinner layer can be formed. When the conductive auxiliary layer is formed by a vacuum deposition method, the thickness of the layer is generally within the range of about 1 to 500 nanometers. In view of increasing the energy density of the power storage device, the thickness of the layer is preferably 100 nanometers or less, and further preferably, 20 nanometers or less.

The weight of the carbonaceous material occupied in the total weight of the conductive auxiliary layer is preferably larger in view of increasing conductivity. The weight is generally 50% by weight or more, and preferably, 66% by weight or more. A conductive auxiliary agent may be added to increase conductivity and a binder may be added to increase mechanical strength.

PTMA, which serves as a cathode active material in the first embodiment, may be constituted of a conventionally known nitroxyl polymer. The nitroxyl polymer of the present invention is a general term representing polymer compounds having a nitroxyl structure typically represented by chemical formula (3). The nitroxyl structure may take the states of chemical formula (I) to (III) shown in the Reaction equation (A), in accordance with electron transfer.

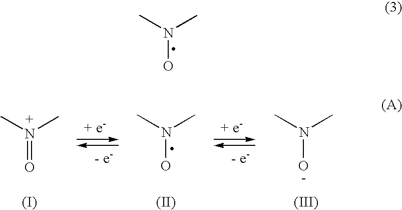

In the power storage device according to the present invention, the reaction between chemical formula (I) and chemical formula (II) is used as the electrode reaction of a cathode to activate storage operation by storing and releasing electrons thereby. The power storage device has at least a cathode and an anode and can take out energy electrochemically stored in the form of electric power. The cathode of the power storage device refers to an electrode having a higher oxidation reduction potential, whereas the anode refers to an electrode having a lower oxidation reduction potential.

In the present invention, as a nitroxyl structure taken in oxidation state, a cyclic nitroxyl structure represented by chemical formula (5) is preferable. In reduction state, the nitroxyl moiety of chemical formula (5) takes the nitroxyl radical structure represented by chemical formula (II). Each of R₁ to R₄ independently represents an alkyl group, and particularly preferably, a straight alkyl group. In view of radical stability, an alkyl group having 1 to 4 carbon atoms is preferable and particularly preferably, a methyl group. In the group X, an atom constituting a member of a ring is selected from the group consisting of carbon, oxygen, nitrogen and sulfur. The group X represents a divalent group which forms a 5- to 7-membered ring in the chemical formula (5). Specific examples of the group X include —CH₂CH₂—,—CH₂CH₂CH₂—,—CH₂CH₂CH₂CH₂—,—CH═CH—,—CH═CHCH₂—,—CH═CHCH₂CH₂—, and —CH₂CH═CHCH₂—. The unadjacent —CH₂— in them may be replaced with —O—, —NH— or —S— and the —CH═ may be replaced with —N═. Furthermore, a hydrogen atom bound to an atom constituting a ring may be replaced with an alkyl group, halogen atom, ═O or the like.

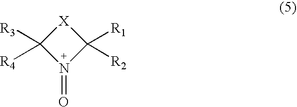

A particularly preferable cyclic nitroxyl structure in oxidation state is selected from the group consisted of a 2,2,6,6-tetramethylpiperidinoxyl cation represented by chemical formula (6), a 2,2,5,5-tetramethylpyrrolidinoxyl cation represented by chemical formula (7) and 2,2,5,5-tetramethylpyrrolinoxyl cation represented by chemical formula (8).

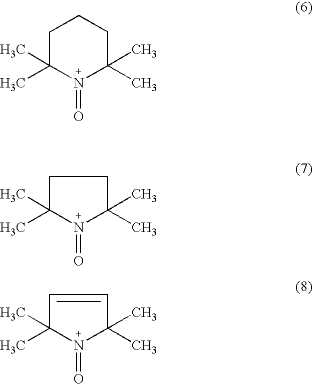

In the present invention, the cyclic nitroxyl structure represented by chemical formula (5) mentioned above constitutes a part of side chain or main chain of a polymer. More specifically, the cyclic nitroxyl group constitutes a part of side chain or main chain of a polymer by removing at least one hydrogen atom bonded to an element forming a cyclic structure. The cyclic nitroxyl group is preferably present in a side chain in view of easiness of synthesis and the like. When the cyclic nitroxyl group is present in a side chain, it is bonded to the main chain polymer via a residue X′, obtained by removing a hydrogen atom from —CH₂—, —CH═; or —NH— which is a member of a group X constituting a ring in chemical formula (5), as shown in chemical formula (9):

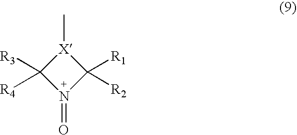

wherein R₁ to R₄ are the same as defined in chemical formula (5).

The main-chain polymer used herein is not particularly limited. Any polymer may be used as long as the residue having a cyclic nitroxyl structure represented by chemical formula (9) is present in a side chain. More specifically, examples include those where a residue represented by chemical formula (9) is added to a following polymer or a part of atoms or groups is replaced by the residue represented by chemical formula (9). In either case, the residue represented by chemical formula (9) may be bonded not directly but via an appropriate divalent group. Examples include: polyalkylene polymers such as polyethylene, polypropylene, polybutene, polydecene, polydodecene, polyheptene, polyisobutene, and polyoctadecene; diene polymers such as polybutadiene, polychloroprene, polyisoprene, and poly isobutene; poly(meth)acrylic acid; poly(meth)acrylonitrile; poly(meth)acrylamide polymers such as poly(meth)acrylamide, polymethyl (meth)acrylamide, poly dimethyl meth)acrylamide, and polyisopropyl (meth)acrylamide; polyalkyl (meth)acrylates such as polymethyl (meth)acrylate, polyethyl (meth)acrylate, and polybutyl (meth)acrylate; fluorine polymers such as polyvinylidene fluoride, and polytetrafluoroethylene; polystyrene polymers such as polystyrene, polybromostyrene, polychlorostyrene, and polymethyl styrene; vinyl polymers such as polyvinyl acetate, polyvinyl alcohol, polyvinylchloride, polyvinylmethyl ether, polyvinylcarbazole, polyvinyl pyridine, and polyvinylpyrrolidone; polyether polymers such as polyethylene oxide, polypropylene oxide, polybutene oxide, polyoxymethylene, polyacetaldehyde, polymethylvinyl ether, polypropylvinyl ether, polybutylvinyl ether, and polybenzylvinyl ether; polysulfide polymers such as polymethylene sulfide, polyethylene sulfide, polyethylene disulfide, polypropylene sulfide, polyphenylene sulfide, polyethylene tetrasulfide, and polyethylene trimethylene sulfide; polyesters such as polyethylene terephthalate, polyethylene adipate, polyethylene isophthalate, polyethylene naphthalate, polyethylene paraphenylene diacetate, and polyethylene isopropylidene dibenzoate; polyurethanes such as polytrimethylene ethylene urethane; polyketone polymers such as polyetherketone and polyallyl etherketone; polyanhydride polymers such as polyoxy isophthaloyl; polyamine polymers such as polyethylene amine, polyhexamethylene amine, and polyethylene trimethylene amine; polyamide polymers such as nylon, polyglycine, and polyalanine; polyimine polymers such as polyacetyl iminoethylene and poly benzoyl iminoethylene; polyimide polymers such as polyesterimide, polyetherimide, polybenzimide, and polypyromelimide; polyaromatic polymers such as polyallylene, polyallylene alkylene, polyallylene alkenylene, polyphenol, phenolic resin, cellulose, polybenzimidazole, polybenzothiazole, polybenzoxazine, polybenzoxazole, polycarborane, polydibenzofuran, polyoxo isoindoline, polyfuran tetracarboxylic diimide, polyoxadiazole, polyoxindole, polyphthalazine, polyphthalide, polycyanurate, polyisocyanurate, polypiperazine, polypiperidine, polypyrazinoquinoxan, polypyrazole, polypyridazine, polypyridine, polypyrromerithymine, polyquinone, polypyrrolidine, polyquinoxaline, polytriazine, and polytriazole; siloxane polymers such as polydisiloxane, polydimethyl siloxane; polysilane polymers; polysilazane polymers; polyphosphazene polymers; polythiazyl polymers; and conjugated polymers such as polyacetylene, polypyrrol, and polyaniline. (Meth)acryl means methacryl or acryl.

Among them, polyalkylene polymers, poly(meth)acrylic acids, poly(meth)acrylamide polymers, polyalkyl (meth)acrylates, polystyrene polymers are preferable since a main chain has excellent electrochemical tolerance. The main chain refers to a carbon chain containing the largest carbon numbers in a polymer compound. Among these polymers, a polymer which can contain a unit represented by the following chemical formula (10) in oxidization state is preferably selected.

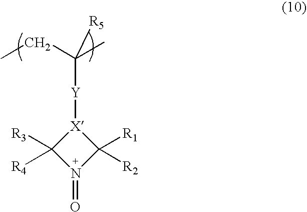

In the formula, R₁ to R₄ are the same as defined in chemical formula (5). R₅ represents a hydrogen or a methyl group. Y is not particularly limited; but may be —CO—, —COO—, —CONR₆—, —O—, —S—, an alkylene group having 1 to 18 carbon atoms that may have a substituent, an arylene group having 1 to 18 carbon atoms that may have a substituent, and a divalent group having these groups in combination of two or more. R₆ represents an alkyl group having 1 to 18 carbon atoms. Among the units represented by chemical formula (10), those represented by the following chemical formulas (11) to (14) are particularly preferable.

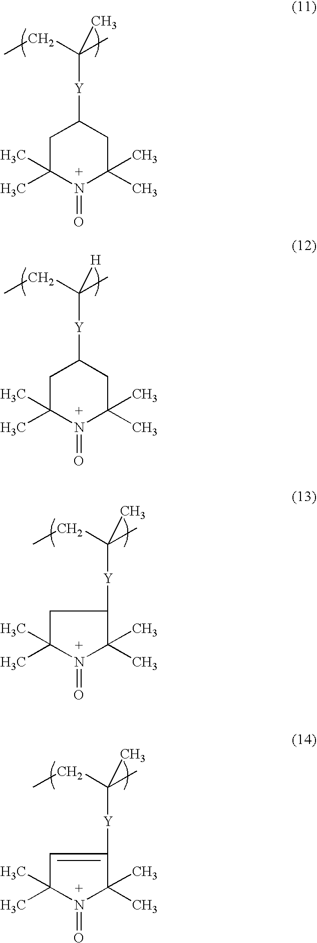

In chemical formulas (11) to (14), Y is the same as defined in chemical formula (10); however, either —COO— or CONR₆— is particularly preferable.

In the present invention, the residue of chemical formula (9) is not necessarily present in all of the side chains. For example, all of the units constituting a polymer may be represented by chemical formula (10) and a part of the units may be represented by chemical formula (10). The content of the residue in the polymer differs depending upon the purpose, structure and a production method, as long as it is present even in a small amount, generally 1% by weight or more, and particularly preferably 10% by weight or more. Synthesis of a polymer is not particularly limited. When desiring as much power storage operation as possible, 50% by weight or more, particularly 80% by weight or more is preferable.

Such a polymer can be is synthesized by, for example, polymerizing a monomer represented by the following chemical formula (15) by itself or by copolymerizing the monomer with a copolymerizable monomer such as alkyl acrylate, followed by oxidizing a —NH— moiety. In this manner, a polymer having a unit represented by chemical formula (10) can be obtained in oxidation state.

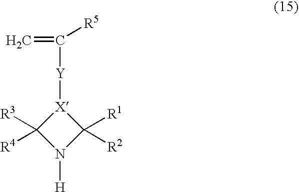

Alternatively, after a base polymer is synthesized by polymerization of methacrylic acid and the like, a residue represented by chemical formula (9) (or a residue having a —NH— before it is oxidized by a NO radical) may be introduced by a polymerization reaction.

The molecular weight of a nitroxyl polymer in the present invention is not particularly limited; but is preferably too large to be dissolved in an electrolyte. Such molecular weight differs depending upon the type of organic solvent in the electrolyte. The weight average molecular weight is generally 1,000 or more, preferably 10,000 or more, and particularly 100,000 or more. Since a nitroxyl polymer may be added in the form of powder to a cathode in the present invention, any molecular weight may be acceptable no matter how it is large. The weight average molecular weight is generally 5,000,000 or less. The polymer containing a residue represented by chemical formula (9) may be crosslinked, so that the durability of an electrolyte can be improved thereby.

The content of a nitroxyl polymer in a cathode, although it is 50% by weight in the first embodiment, may be arbitrarily adjusted. The nitroxyl polymer in the cathode primarily has a function as an active material contributing to storage of power. Therefore, the entire amount of the cathode active material of a conventional power storage device such as conventional battery can be replaced with the nitroxyl polymer defined by the present invention. It is effective enough if the nitroxyl polymer is added in an amount of 10% by weight or more based on the total amount of a cathode. When desiring as much power storage operation as possible, 50% by weight or more, particularly 80% by weight or more is preferable and 100% by weight is also preferable.

The content of a conductivity imparting argent in the cathode, although it is 30% by weight in the first embodiment, may be arbitrarily adjusted. When the content of the conductivity imparting agent in a cathode is higher, sufficient conductivity can be obtained even in the case where the cathode is directly formed on the aluminum metal by coating or compression. Therefore, the effect of the conductive auxiliary layer according to the present invention is more significantly produced in the case where the content of the conductivity imparting agent in the cathode is lower. The effect of the conductive auxiliary layer of the present invention is larger when the content of the conductivity imparting agent in the cathode is 50% by weight or less, and significantly larger particularly in the content of 40% by weight or less.

The cathode active material, which is PTMA alone in the first embodiment, may be used in combination with another type of cathode active material to form a cathode. A conventionally known electrode material of a power storage device can be used as the other type of cathode active material. Examples of them include carbonaceous materials such as activated carbon, graphite, carbon black, and acetylene black; metal oxides such as LiMnO₂, LiCoO₂, LiNiO₂ and LiₓV₂O₅ (0<x<2); conductive polymers such as polyacetylene, polyphenylene, polyaniline and polypyrrol; and disulfide compounds.

A power storage device can be formed by replacing the conductivity imparting agent containing acetylene black as a main component used in the first embodiment with a conventionally known conductivity imparting material. Examples of the conventionally known conductivity imparting material include activated carbon, graphite, carbon black and furnace black and metal powder.

A power storage device can be formed by replacing the binder using tetrafluoroethylene in the first embodiment with a conventionally known binder. Examples of the conventionally known binder include resin binders such as polyvinylidene fluoride, vinylidene fluoride-hexafluoropropylene copolymer, styrene-butadiene copolymer rubber, polypropylene, polyethylene, and polyimide. Depending upon the type of the main chain having a cyclic nitroxyl structure, the type of a side chain having the cyclic nitroxyl structure bonded thereto, or the type of a side chain having no cyclic nitroxyl structure, the polymer may also have a function as a binder. In such a case, a conventional binder may not be required or the amount of the binder may be reduced. Alternatively, a conventional active material may be used as it is and a polymer having a cyclic nitroxyl structure may be used as a binder. In this case, the polymer having a cyclic nitroxyl structure added in an amount corresponding to that of the binder has also a function as an active material, with the result that the power storage capacity can be increased thereby. On the other hand, when the main chain of the polymer is formed of a conductive polymer such as polyacetylene and polyaniline and a cyclic nitroxyl structure is present in a side chain, the polymer having a cyclic nitroxyl structure may also have a function as a conductive auxiliary agent. In this case, a conventional conductive auxiliary agent may not be required or the amount of the conventional conductive auxiliary agent may be reduced. Alternatively, the conventional active materials may be used as it is and a polymer having a cyclic nitroxyl structure may be used as the conductive auxiliary agent. In this case, the polymer having a cyclic nitroxyl structure added in an amount corresponding to that of the conductive auxiliary agent has also a function as an active material, with the result that the power storage capacity can be increased thereby. The nitroxyl cation structure may have a function of inactivating impurities such as water and alcohol contained in an electrolyte, thereby preventing the performance of a power storage device from deteriorating. In any case, a polymer having a cyclic nitroxyl structure is particularly effective since it has low solubility in an electrolyte containing an organic solvent and a high durability.

A power storage device can be formed by replacing an anode, which is formed of a lithium metal in the first embodiment, with a conventionally known anode. Examples of the conventionally known anode include carbonaceous materials such as active carbon, graphite, carbon black, and acetylene black; single metals and alloys such as a lithium alloy, lithium ion occlusion carbon, and various types; conductive polymers such as polyacetylene, polyphenylene, polyaniline and polypyrrol; resin binders such as polyvinylidene fluoride, polytetrafluoroethylene, vinylidene fluoride-hexafluoropropylene copolymer, styrene-butadiene copolymer rubber, polypropylene, polyethylene, and polyimide; disulfide compounds; compounds having a catalytic effect; and ion conductive polymers.

A power storage device can be formed by replacing the material of the anode metal collector, which is formed of stainless steel in the first embodiment, with a conventionally known material. Examples of the conventionally known material for the anode metal collector include nickel, aluminum, copper, gold, silver, titanium, and an aluminum alloy. They may be in the form of foil, flat surface, and mesh.

A power storage device can be formed by replacing the material of the cathode metal collector, which is formed of stainless steel in the first embodiment, with a conventionally known material. Examples of the conventionally known material for the cathode metal collector include nickel, aluminum, copper, gold, silver, titanium, and an aluminum alloy. They may be in the form of foil, flat surface, and mesh. Furthermore, the cathode metal collector may not be used and aluminum used as a cathode collector may be used in place of the cathode metal collector.

A power storage device can be formed by replacing the electrolyte using an EC/DEC mixture solution containing an electrolyte salt, LiPF₆ (1 mol/L) in the first embodiment, with a conventionally known electrolyte. The electrolyte has a function of transporting charge carriers between the anode 3 and the cathode 5 and generally has an electrolyte ion conductivity of 10⁻⁵ to 10⁻¹ S/cm at room temperature. As the conventionally known electrolyte, an electrolyte having an electrolyte salt dissolved in a solvent may be used. Examples of the solvent include organic solvents such as ethylene carbonate, propylene carbonate, dimethyl carbonate, diethyl carbonate, methyl ethyl carbonate, γ-butyrolactone, tetrahydrofuran, dioxolane, sulfolane, dimethyl formamide, dimethyl acetamide, and N-methyl-2-pyrrolidone; an aqueous solution of sulfuric acid, and water. These solvents may be used alone or in a mixture of two or more types in the present invention. Examples of the electrolyte salt include LiPF₆, LiClO₄, LiBF₄, LiCF₃SO₃, LiN(CF₃SO₂)₂, LiN(C₂F₅SO₂)₂, LiC(CF₃SO₂)₃, and LiC(C₂F₅SO₂)₃. Furthermore, a solid electrolyte may be used as the electrolyte for the present invention. Examples of organic solid electrolyte materials as the solid electrolyte include vinylidene fluoride polymers such as polyvinylidene fluoride and vinylidene fluoride-hexafluoropropylene copolymer; acrylonitrile polymer such as acrylonitrile-methyl methacrylate copolymer and acrylonitrile-methyl acrylate copolymer; and polyethylene oxide. These polymer materials may be used in the form of gel by impregnated with an electrolyte. Alternatively, the polymer materials containing an electrolyte salt can be used as they are. On the other hand, examples of inorganic solid electrolytes include CaF₂, Agl, LiF, β-alumina and glass material.

A power storage device can be formed by replacing the material for a separator, which is formed of a polypropylene porous film in the first embodiment, with a conventional material. Examples of the conventional material for the separator include polyethylene and the like.

### EXAMPLES

A method of manufacturing a device according to an embodiment will be described by way of examples.

<Synthesis of a Polymer Having a Cyclic Nitroxyl Structure>

In a 100 ml eggplant flask equipped with a reflux tube, 20 g (0.089 mol) of a 2,2,6,6-tetramethylpiperidine methacrylate monomer was placed and dissolved in 80 ml of dry tetrahydrofuran. To the solution, 0.29 g (0.00178 mol) of azobisisobutyronitrile (AIBN) (monomer/AIBN=50/1) was added and the resultant mixture was stirred under argon atmosphere at 75 to 80° C. After the reaction was performed for 6 hours, it was cooled to room temperature. The polymer was precipitated in hexane, separated by filtration, and dried under vacuum to obtain 18 g of poly(2,2,6,6-tetramethylpiperidine methacrylate) in a yield of 90%. Subsequently, 10 g of poly(2,2,6,6-tetramethylpiperidine methacrylate) thus obtained was dissolved in 100 ml of dry dichloromethane. To the solution, 100 ml of a dichloromethane solution of 15.2 g (0.088 mol) of m-chloroperbenzoic acid was dropped at room temperature while stirring for one hour. After further stirring for 6 hours, precipitated m-chlorobenzoic acid was filtered off and the filtrate was washed with an aqueous solution of sodium carbonate and water, and then dichloromethane was distilled away. The remaining solid was pulverized and the obtained powder was washed with diethylcarbonate (DEC), and then, dried under vacuum to obtain 7.2 g of poly(2,2,6,6-tetramethylpiperidinoxy methacrylate) (PTMA) represented by chemical formula (16) in a yield of 68.2% as brown powder. The structure of the polymer thus obtained was confirmed by IR. As a result of GPC measurement, the weight average molecular weight (Mw) was 89,000 and dispersion Mw/Mn was 3.30. The spin density obtained from an ESR spectrum was 2.26×10²¹ spin/g. This value coincides with the spin density on the assumption that 90% of the N—H groups of poly(2,2,6,6-tetramethylpiperidine methacrylate) are converted into N—O radicals.

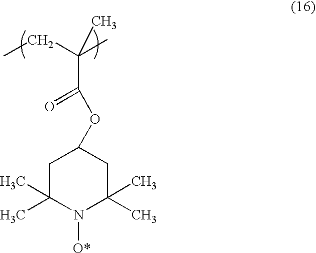

In the same manner, poly(2,2,6,6-tetrametylpiperidinoxy acrylate) represented by chemical formula (17) (weight average molecular weight Mw=74,000, dispersion Mw/Mn=2.45, the spin density: 2.23×10²¹ spin/g which coincides with the spin density on the assumption that 84% of the N—H groups is converted to N—O radicals); poly(2,2,5,5 tetramethylpyrrolidinoxy methacrylate) represented by chemical formula (18) (weight average molecular weight Mw=52,000, dispersion Mw/Mn=3.57, the spin density: 1.96×10²¹ spin/g which coincides with the spin density on the assumption that 74% of the N—H groups is converted to N—O radicals); and poly(2,2,5,5-tetramethylpyrrolinoxy methacrylate) represented by chemical formula (19) (weight average molecular weight Mw=33,000, dispersion Mw/Mn=4.01, the spin density: 2.09×10²¹ spin/g which coincides with the spin density on the assumption that 78% of the N—H groups is converted to N—O radicals) were synthesized.

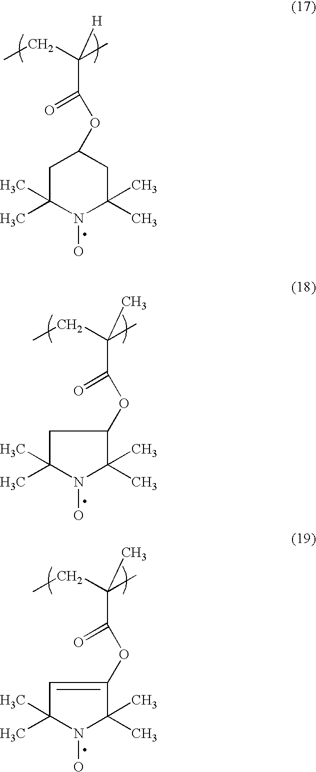

### Example 1

20 g of pure water was weighed and placed in a small homogenizer container. To the container, 272 mg of the binder consisted of Teflon (registered trade mark) particles and cellulose was added and completely dissolved by stirring for 3 minutes. To the mixture, 2.0 g of acetylene black was added and stirred for 15 minutes to obtain a slurry. The obtained slurry was thinly applied onto an aluminum plate with the thickness of 20 micron, and dried at 100° C. to form a conductive auxiliary layer. The thickness of the conductive auxiliary layer was 10 microns. In this way, a cathode collector was obtained having the conductive auxiliary layer containing carbon as a main component integrated with the aluminum plate.

Next, 20 g of N-methyl pyrrolidone was weighed and placed in a small homogenizer container. To the container, 400 mg of polyvinylidene fluoride was added and completely dissolved by stirring for 30 minutes. To the mixture, 1.0 g of synthetic polymethacrylate represented by chemical formula (16) as a cathode active material was added and stirred for 5 minutes. When the whole mixture turned uniformly to orange, 600 mg of acetylene black was added and stirred for 15 minutes. The resultant sample was defoamed to obtain slurry. The obtained slurry was applied onto the cathode collector having the conductive auxiliary layer containing carbon as a main component integrated on the aluminum plate and dried at 125° C. to form a cathode. The thickness of the cathode was 80 microns.

The electrode plate, in which the cathode containing the polymethacrylate represented by chemical formula (16) was formed by applying onto the cathode collector having the conductive auxiliary layer containing carbon as a main component integrated on the aluminum plate, was mounted on a cathode metal collector (stainless steel plate) and dried at 80° C. under vacuum overnight and punched to form a disk shape with a diameter of 12 mm to form a electrode for a power storage device. Next, the electrode thus obtained was dipped into an electrolyte and spaces inside the electrode were impregnated with the electrolyte. As the electrolyte, an EC/DEC mixture solution (the volume ratio of EC/DEC is 3/7) containing 1 mol/L of an LiPF₆ electrolytic salt was used. Next, on the electrode impregnated with the electrolyte, a porous film separator (made of polypropylene) impregnated with the electrolyte in the same manner was laminated. Further, a lithium metal plate as an anode was laminated and an anode collector (stainless steel plate) coated with insulating packing (made of polypropylene) was put on. The laminate formed in this manner was pressed by a caulker to obtain a coin-type power storage device.

### Example 2

The same procedure as in Example 1 was conducted except that the synthetic polyacrylate represented by chemical formula (17) was used as the cathode active material, to obtain a coin-type power storage device.

### Example 3

The same procedure as in Example 1 was conducted except that the synthetic polymethacrylate represented by chemical formula (18) was used as the cathode active material, to obtain a coin-type power storage device.

### Example 4

The same procedure as in Example 1 was conducted except that the synthetic polymethacrylate represented by chemical formula (19) was used as the cathode active material, to obtain a coin-type power storage device.

### Example 5

The same procedure as in Example 1 was conducted except that a graphite electrode plate was used as the anode, to obtain a coin-type power storage device.

### Example 6

The same procedure as in Example 1 was conducted except that the amount of acetylene black to be mixed with a cathode active material was 156 mg, to obtain a coin-type power storage device.

### Example 7

The same procedure as in Example 1 was conducted except that the amount of acetylene black to be mixed with a cathode active material was 350 mg, to obtain a coin-type power storage device.

### Example 8

The same procedure as in Example 1 was conducted except that the amount of acetylene black to be mixed with a cathode active material was 933 mg, to obtain a coin-type power storage device.

### Example 9

The same procedure as in Example 1 was conducted except that the amount of acetylene black to be mixed with a cathode active material was 1,400 mg, to obtain a coin-type power storage device.

### Example 10

The same procedure as in Example 1 was conducted except that the amount of acetylene black to be mixed with a cathode active material was 2,100 mg, to obtain a coin-type power storage device.

### Example 11

The same procedure as in Example 1 was conducted except that the thickness of a conductive auxiliary layer to be formed on the aluminum plate was 30 microns, to obtain a coin-type power storage device.

### Example 12

The same procedure as in Example 1 was conducted except that the thickness of a conductive auxiliary layer to be formed on the aluminum plate was 5 microns, to obtain a coin-type power storage device.

### Example 13

Amorphous carbon was deposited on the aluminum electrode by a carbon deposition device to form a conductive auxiliary layer. The thickness of the conductive auxiliary layer was 30 nanometers. Thereafter, the same procedure as in Example 1 was conducted to obtain a coin-type power storage device.

### Comparative Example 1

20 g of N-methyl pyrrolidone was weighed and placed in a small homogenizer container. To the container, 400 mg of polyvinylidene fluoride was added and completely dissolved by stirring for 30 minutes. To the mixture, 1.0 g of synthetic polymethacrylate represented by chemical formula (16) as a cathode active material was added and stirred for 5 minutes. When the whole mixture turned uniformly to orange, 600 mg of acetylene black was added and stirred for 15 minutes. The resultant sample was defoamed to obtain slurry. The obtained slurry was applied directly onto an aluminum plate and dried at 125° C. to form a cathode. The thickness of the cathode was 80 microns.

The electrode plate, in which the cathode containing the polymethacrylate represented by chemical formula (16) was formed by applying on the aluminum plate, was mounted on a cathode metal collector (stainless steel plate) and dried at 80° C. under vacuum overnight and punched to form a disk shape with a diameter of 12 mm to form a electrode for a power storage device. Thereafter, the same procedure as in Example 1 was conducted to obtain a coin-type power storage device.

### Comparative Example 2

The same procedure as in Comparative Example 1 was conducted except that synthetic polyacrylate represented by chemical formula (17) was used as a cathode active material, to obtain a coin-type power storage device.

### Comparative Example 3

The same procedure as in Comparative Example 1 was conducted except that synthetic polymethacrylate represented by chemical formula (18) was used as a cathode active material, to obtain a coin-type power storage device.

### Comparative Example 4

The same procedure as in Comparative Example 1 was conducted except that synthetic polymethacrylate represented by chemical formula (19) was used as a cathode active material, to obtain a coin-type power storage device.

### Comparative Example 5

The same procedure as in Comparative Example 1 was conducted except that a graphite electrode plate was used as the anode, to obtain a coin-type power storage device.

### Comparative Example 6

The same procedure as in Comparative Example 1 was conducted except that the amount of acetylene black to be mixed with a cathode active material was 156 mg, to obtain a coin-type power storage device.

### Comparative Example 7

The same procedure as in Comparative Example 1 was conducted except that the amount of acetylene black to be mixed with a cathode active material was 350 mg, to obtain a coin-type power storage device.

### Comparative Example 8

The same procedure as in Comparative Example 1 was conducted except that the amount of acetylene black to be mixed with a cathode active material was 933 mg, to obtain a coin-type power storage device.

### Comparative Example 9

The same procedure as in Comparative Example 1 was conducted except that the amount of acetylene black to be mixed with a cathode active material was 1,400 mg, to obtain a coin-type power storage device.

### Comparative Example 10

The same procedure as in Comparative Example 1 was conducted except that the amount of acetylene black to be mixed with a cathode active material was 2,100 mg, to obtain a coin-type power storage device.

The open potential of the power storage device manufactured in Example 1 was 2.9 V. The power storage device thus obtained was charged with a constant current of 0.113 mA and the charge operation was terminated when the voltage increased to 4.0 V. When the power storage device charged was taken apart and the cathode was analyzed, a reduction of radical concentration was observed and production of corresponding a 2,2,6,6-tetramethylpiperidinoxyl cation was confirmed. The cation was stabilized with anion PF₆⁻ of the electrolyte.

A power storage device was manufactured in the same manner and charged with a constant current of 0.113 mA. Immediately after the voltage increased to 4.0 V, discharge was performed. The discharge was performed at a constant current of 0.113 mA which is the same as in the charge operation and the discharge operation was terminated when the voltage decreased to 3.0 V. During the discharge operation, a flat portion was observed at about 3.5 V in the voltage profile. The flat voltage portion was found to correspond to the potential difference between the reduction reaction taking place at the cathode in which a nitroxyl cation changes to a nitroxyl radical and the ionization reaction of a lithium metal taking place at the anode. More specifically, this result evidently shows that the power storage device of Example 1 serves as a chemical battery. An average discharge voltage in Example 1 was 3.50 V.

Charge-discharge behaviors of the power storage devices manufactured in Examples 2 to 13 and Comparative Examples 1 to 10 were evaluated in the same manner. Table 1 summarizes the average discharge voltages when discharge was-performed at a constant current of 0.113 mA in Examples 1 to 13 and Comparative Examples 1 to 10. In the cases in which the cathode active material and the anode active material used are the same kind, the higher the average discharge voltage is, the lower the internal resistance of the power storage device is; and the lower the average discharge voltage is, the higher the internal resistance of the power storage device is.

When Example 1 is compared to Comparative Example 1 ,it is found that the average discharge voltage of a power storage device is increased, in other words, the internal resistance is decreased, by use of a cathode collector in which a conductive auxiliary layer containing carbon as a main component is formed and integrated on an aluminum electrode. When Examples 2 to 4 are compared to Comparative Examples 2 to 4, even if any one of the cathode active materials of chemical formulas (17) to (19) is used, it is found that the average discharge voltage of a power storage device is increased, in other words, the internal resistance is decreased, by use of a cathode collector in which a conductive auxiliary layer containing carbon as a main component is formed and integrated on an aluminum electrode. When Example 5 is compared to Comparative Example 5, even if graphite is used as an anode active material, it is found that the average discharge voltage of a power storage device is increased, in other words, the internal resistance is decreased, by use of a cathode collector in which a conductive auxiliary layer containing carbon as a main component is formed and integrated on an aluminum electrode. When Examples 6 to 8 are compared to Comparative Examples 6 to 8, if the content of a conductivity imparting agent occupied in the cathode is in the range of 10 to 40% by weight, it is found that the effect of increasing the average discharge voltage of a power storage device, in other words, decreasing the internal resistance is significantly produced, which are obtained by use of a cathode collector in which a conductive auxiliary layer containing carbon as a main component is formed and integrated on an aluminum electrode. When Example 9 is compared to Comparative Example 9, if the content of a conductivity imparting agent occupied in the cathode is 50% by weight, it is found that the effect of increasing the average discharge voltage of a power storage device is, in other words, decreasing the internal resistance is slightly reduced, which are obtained by use of a cathode collector in which a conductive auxiliary layer containing carbon as a main component is formed and integrated on an aluminum electrode. When Example 10 is compared to Comparative Example 10, if the content of a conductivity imparting agent occupied in the cathode is 60% by weight, it is found that the effect of increasing the average discharge voltage of a power storage device, in other words, decreasing the internal resistance is further reduced, which are obtained by use of a cathode collector in which a conductive auxiliary layer containing carbon as a main component is formed and integrated on an aluminum electrode. When Examples 1, 11 and 12 are compared to Comparative Example 1, when the thickness of the conductive auxiliary layer is 5, 10, and 20 microns, it is found that the effect of increasing the average discharge voltage of a power storage device, in other words, decreasing the internal resistance is produced in the same manner, which are obtained by use of a cathode collector in which a conductive auxiliary layer containing carbon as a main component is formed and integrated on an aluminum electrode. When Example 13 is compared to Comparative Example 1, even if the conductive auxiliary layer is formed by a deposition method, it is found that the effect of increasing the average discharge voltage of a power storage device, in other words, decreasing the internal resistance is produced, which are obtained by use of a cathode collector in which a conductive auxiliary layer containing carbon as a main component is formed and integrated on an aluminum electrode.

TABLE 1

| | | | Ratio of | Method of | | | |
|---|---|---|---|---|---|---|---|
| | Cathode | Anode | electro-conductivity | forming | Thickness of | | Average |
| | active | active | imparting agent | conductive | conductive | | discharge |
| Ex. | material | material | occupied in cathode | auxiliary layer | auxiliary layer | | voltage |
| Ex. 1 | Chemical | Lithium | 30% by weight | Coating | 10 | microns | 3.50 V |
| | formula 16 | metal | | | | | |
| Ex. 2 | Chemical | Lithium | 30% by weight | Coating | 10 | microns | 3.47 V |
| | formula 17 | metal | | | | | |
| Ex. 3 | Chemical | Lithium | 30% by weight | Coating | 10 | microns | 3.46 V |
| | formula 18 | metal | | | | | |
| Ex. 4 | Chemical | Lithium | 30% by weight | Coating | 10 | microns | 3.55 V |
| | formula 19 | metal | | | | | |
| Ex. 5 | Chemical | Graphite | 30% by weight | Coating | 10 | microns | 3.40 V |
| | formula 16 | | | | | | |
| Ex. 6 | Chemical | Lithium | 10% by weight | Coating | 10 | microns | 3.45 V |
| | formula 16 | metal | | | | | |
| Ex. 7 | Chemical | Lithium | 20% by weight | Coating | 10 | microns | 3.47 V |
| | formula 16 | metal | | | | | |
| Ex. 8 | Chemical | Lithium | 40% by weight | Coating | 10 | microns | 3.51 V |
| | formula 16 | metal | | | | | |
| Ex. 9 | Chemical | Lithium | 50% by weight | Coating | 10 | microns | 3.55 V |
| | formula 16 | metal | | | | | |
| Ex. 10 | Chemical | Lithium | 60% by weight | Coating | 10 | microns | 3.56 V |
| | formula 16 | metal | | | | | |
| Ex. 11 | Chemical | Lithium | 30% by weight | Coating | 30 | microns | 3.51 V |
| | formula 16 | metal | | | | | |
| Ex. 12 | Chemical | Lithium | 30% by weight | Coating | 5 | microns | 3.49 V |
| | formula 16 | metal | | | | | |
| Ex. 13 | Chemical | Lithium | 30% by weight | Deposition | 30 | nanometers | 3.49 V |
| | formula 16 | metal | | | | | |

| | | | | | | |
|---|---|---|---|---|---|---|
| Comp. | Chemical | Lithium | 30% by weight | — | — | 3.45 V |
| Ex. 1 | formula 16 | metal | | | | |
| Comp. | Chemical | Lithium | 30% by weight | — | — | 3.42 V |
| Ex. 2 | formula 17 | metal | | | | |
| Comp. | Chemical | Lithium | 30% by weight | — | — | 3.41 V |
| Ex. 3 | formula 18 | metal | | | | |
| Comp. | Chemical | Lithium | 30% by weight | — | — | 3.49 V |
| Ex. 4 | formula 19 | metal | | | | |
| Comp. | Chemical | Graphite | 30% by weight | — | — | 3.34 V |
| Ex. 5 | formula 16 | | | | | |
| Comp. | Chemical | Lithium | 10% by weight | — | — | 3.20 V |
| Ex. 6 | formula 16 | metal | | | | |
| Comp. | Chemical | Lithium | 20% by weight | — | — | 3.23 V |
| Ex. 7 | formula 16 | metal | | | | |
| Comp. | Chemical | Lithium | 40% by weight | — | — | 3.32 V |
| Ex. 8 | formula 16 | metal | | | | |
| Comp. | Chemical | Lithium | 50% by weight | — | — | 3.50 V |
| Ex. 9 | formula 16 | metal | | | | |
| Comp. | Chemical | Lithium | 60% by weight | — | — | 3.55 V |
| Ex. 10 | formula 16 | metal | | | | |

### INDUSTRIAL APPLICABILITY

Since a power storage device according to the present invention has low internal resistance, it can be used as a power storage device for providing high power. The present invention may be applied to back-up power sources for personal computers and servers, auxiliary power sources of electric cars, power sources for mobile device and the like, which have been conventionally employing electric double layer capacitors, Pb storage batteries, nickel hydrogen batteries, and lithium ion secondary batteries and the like.

1. A power storage device comprising a nitroxyl polymer which has a nitroxyl cation partial structure represented by the following chemical formula (I) in oxidation state and has a nitroxyl radical partial structure represented by the following chemical formula (II) in reduction state, in a cathode; employing a reaction for transferring an electron between the two states represented by the following equation (B) as an electrode reaction of the cathode; and using a cathode collector having a conductive auxiliary layer comprising carbon as a main component formed and integrated on an aluminum electrode.

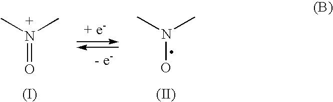

2. The power storage device according to claim 1, further comprising an electro-conductivity imparting agent in the cathode, wherein the content of the electro-conductivity imparting agent in the cathode is 50% by weight or less.

3. The power storage device according to claim 2, wherein the content of the electro-conductivity imparting agent is 40% by weight or less.

4. The power storage device according to claim 1, wherein the nitroxyl polymer is a polymer compound having a cyclic nitroxyl structure represented by the following chemical formula (5) in oxidation state: 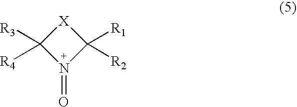
wherein each of R₁ to R₄ independently represents an alkyl group, and X represents a divalent group so that the chemical formula (5) forms a 5- to 7-membered ring, while X constitutes a part of a side chain or a main chain of the polymer.

5. The power storage device according to claim 4, wherein the nitroxyl polymer is a polymer compound having a side chain containing a residue which removes at least one hydrogen atom bonded to an element forming at least one cyclic nitroxyl structure selected from the group consisting of a 2,2,6,6-tetramethylpiperidinoxyl cation represented by chemical formula (6), a 2,2,5,5-tetramethylpyrrolidinoxyl cation represented by chemical formula (7) and a 2,2,5,5-tetramethylpyrrolinoxyl cation represented by chemical formula (8). [chemical structure]
